(19) United States
(12) Patent Application Publication
(10) Pub. No.: US 2014/0338620 A1
(43) Pub. Date: Nov. 20, 2014

(54) MARKING LABELS FOR DRIVE CHAINS

(71) Applicant: IWIS MOTORSYSTEME GMBH & CO. KG, Munchen (DE)

(72) Inventor: Jens PALME, Unterhaching (DE)

(21) Appl. No.: 14/278,650

(22) Filed: May 15, 2014

(30) Foreign Application Priority Data
May 16, 2013 (DE) 10 2013 008 481.4

(51) Int. Cl. F01L 1/02; G09F 3/10; G09F 3/00

(52) U.S. Cl. CPC F01L 1/022; G09F 3/0286; G09F 3/10; G09F 2003/023
USPC 123/90.31; 156/60

(57) ABSTRACT

A drive chain for an internal combustion engine, e.g. a timing chain, comprises a plurality of chain links, which each include at least one chain link plate and which are interconnected via a chain hinge. At least one chain link plate is provided with a mark configured as a label and affixed to the chain link plate by means of an adhesive layer. In addition, a method is provided for marking a drive chain for an internal combustion engine, comprising a plurality of chain links, which each include at least one chain link plate and which are interconnected via a chain hinge, wherein a label is affixed to at least one chain link plate.

### CROSS-REFERENCE TO RELATED APPLICATION

This application claims priority to foreign German patent application No. DE 102013008481.4, filed on May 16, 2013, the disclosure of which is incorporated by reference in its entirety.

### FIELD OF THE INVENTION

The present invention relates to a drive chain for an internal combustion engine, in particular a timing chain, comprising a plurality of chain links, which each include at least one chain link plate and which are interconnected via a chain hinge, at least one chain link plate being provided with a mark. In addition, the invention relates to a method for marking such a drive chain comprising a plurality of chain links.

### BACKGROUND

Drive chains are used in the automotive sector as timing chains for internal combustion engines and they are also used for driving auxiliary units. Timing chains connect the crankshaft chain wheel to at least one camshaft chain wheel of the engine in internal combustion engines and ensure that the crankshaft rotates in synchronism with the camshaft. For precisely adjusting a timing chain drive, the chain wheels as well as the timing chain have marks provided thereon, which allow a precise positioning of the angular position of the crankshaft relative to the camshaft.

Also in the case of other drive chains it is, in addition, common practice to provide at least part of the chain links with marks so as to anchor specific information concerning the drive chain on the chain itself.

Drive chains for internal combustion engines are, during operation, exposed to very aggressive surroundings at high operating temperatures. Hence, also the marks on chain link plates of the drive chains must be capable of resisting the high temperatures of the engine oil as well as the aggressive ingredients of the engine oil.

Timing marks on timing chains are normally provided by means of individual chain link plates which are marked prior to assembling the timing chain, or special copper link plates are systematically introduced in the chain assembly process. For the purpose of marking chain link plates, embossing processes as well as marking processes by means of laser are used. The publication DE 43 39 321 A1 describes such a method of marking chain link plates with the aid of a laser beam. In addition, EP 1 229 267 B1 discloses a method of manufacturing a timing chain provided with marks, according to which colored marks are applied to the outer link plate by means of baking a colored coating.

Just as the special copper marking link plates, also chain link plates having markings produced by means of stamping, laser engraving, baking of colored coatings are provided separately from the other chain link plates of the drive chain for the manufacturing process. It is therefore necessary to systematically supply during the drive chain assembly process not only the conventional chain link plates but also chain link plates having marks thereon. In addition to the drawback of higher storage costs, the systematic supply of marked chain link plates to the assembly process also leads to a complex production sequence entailing the risk of delays, and to an increase in downtimes and in the reject rate.

### SUMMARY OF THE INVENTION

It is therefore the object of the present invention to provide a drive chain for an internal combustion engine, which includes at least one chain link plate provided with a mark and which reduces or eliminates the drawbacks known in connection with conventional timing drive chains having marks thereon.

In the case of a generic drive chain, this object is achieved in that the mark is configured as a label, said label being affixed to the at least one chain link plate by means of an adhesive layer. The use of an affixed label as a mark allows a very simple identification, which is cost-efficient and does not affect the chain link plates, i.e. no hydrogen embrittlement of the chain link plates and no wear through copper chips when copper link plates are used. In addition, adhesive labels can be applied to the chain link plates at any moment in time of the production process of the drive chain, so that a separate supply of marked chain link plates to the assembly process of the drive chain can be avoided. This allows a reliable and direct identification of drive chains, and marking link plates, e.g. outer link plates made of copper, which have hitherto been installed such that no load is applied thereto are no longer necessary and are replaced by outer link plates subjected to load during the process. The use of a label allows not only marking of the drive chain as such, but it also allows detailed product data to be accommodated on the label. The labels can also be configured such that their surface is very small, so that also drive chains having very small dimensions can be identified. Conventional drive chains, which are normally configured with alternate inner chain links and outer chain links, are usually marked by means of the label on the outer link plate, so that no damage will be caused to the label through the drive chain itself.

According to a preferred embodiment, the label is made of a plastic material, preferably of polyester. Labels made of plastic exhibit a high resistance to oil and other aggressive ingredients of engine oil. Labels made of a plastic material are therefore well suited for use with drive chains for internal combustion engines. It will be expedient to choose preferably polyester as a plastic material. A label made of polyester is resistant to high temperatures and can easily be provided with detailed marks and information. According to a further embodiment, the plastic material of the label exhibits a temperature resistance of at least 130° C., preferably of at least 150° C. The marking labels applied to a chain link plate by means of an adhesive layer can thus also be used at high operating temperatures in an internal combustion engine, without the identification of the drive chain, e.g. the timing mark, being rendered undiscernible after only a short period of operation of the drive chain in an internal combustion engine.

According to an advantageous embodiment, the label may be configured as a polyester film, the thickness of the polyester film being less than 0.1 mm, preferably less than 0.05 mm. The label can thus easily be processed and easily be printed on, so as to apply not only marks but also detailed product data. It will be advantageous to configure the label as a laminate film, wherein a first polyester film with marking information is covered with a second, transparent polyester film. The first polyester film may have applied thereto the mark and, optionally, further product data by means of a suitable method, e.g. screen printing, whereas the second, transparent polyester film protects this colored mark against the aggressive surroundings in an internal combustion engine, at least against the aggressive chemical components of the engine oil. This also guarantees a good discernability and readability of the label after it has been used in an internal combustion engine. A thickness of the first and second polyester film of less than 0.05 mm, preferably less than 0.03 mm, will be expedient.

According to another embodiment, the label is configured as a self-adhesive label, the layer of adhesive adhering to the label. A self-adhesive label allows the label to be applied to the chain link plate of the drive chain in one production step.

According to an advantageous embodiment, an adhesive of the adhesive layer comprises a cross-linked acrylate polymer. This provides in addition to a high temperature resistance of the adhesive layer also a high adhesive power, which means that the label will not detach itself, not even after a long period of use and under aggressive ambient conditions in an internal combustion engine, and marking of the chain link plate will be guaranteed. In addition, an adhesive on a basis of a cross-linkable acrylate polymer allows the label to adhere to the chain link plates even if, due to the production of the drive chain, the surface of the chain link plates should slightly or even heavily lubricated with oil. Also other contaminations of the chain link plate surface have no or only very little effect on the adherence of the label. According to a particularly advantageous embodiment, 85% to 95% of the whole polymer content of the adhesive may consist of the cross-linkable acrylate polymer. Configuring the adhesive in this way on the basis of a cross-linkable acrylate polymer will also prevent corrosion of the chain link plates through the adhesive layer.

According to a special embodiment, the cross-linkable acrylate polymer of the adhesive comprises methylacrylate and/or acrylic acid. Thus, a good resistance to oil and acids is accomplished also when the drive chain is used in an internal combustion engine. Especially in combination with an antioxidant, this will allow a homogeneous distribution of the cross-linking agent in the acrylate polymer and, consequently, also a good adhesive power of the adhesive layer.

Preferably, the adhesive may comprise a pressure-activable cross-linking agent. Easy activation of the adhesive layer will thus be achieved by the contact pressure during application of the label, the pressure-activable cross-linking agent allowing a high adhesion permanence depending on the contact pressure applied.

According to one variant, the adhesive comprises a heat-activable cross-linking agent. This allows the adhesive layer to be reliably activated by an adjustable and reliably monitorable heat effect on the label. The temperature for activating the cross-linking agent may be at least 80° C., preferably at least 130° C., and particularly preferred 150° C., a higher activation temperature increasing the maximum temperature of use depending on the temperature resistance of the adhesive and improving the adhesion permanence at high temperatures of use.

For reliably affixing the label to the chain link plate also in the case of slightly or even heavily oil-wetted surfaces, the adhesive of the adhesive layer may have an adhesive power of at least 20 N/25 mm, preferably at least 25 N/25 mm. These adhesive powers have been determined with respect to a steel surface by means of the FINAT Test Method (FTM), all the tests being carried out after keeping the specimen in a standard atmosphere, i.e. at +23° C. and 50% relative humidity, for 48 hours according to DIN 50014.

Furthermore, the present invention relates to a method for marking a drive chain for an internal combustion engine, in particular a timing chain, comprising a plurality of chain links, which each include at least one chain link plate and which are interconnected via a chain hinge, said method according to the present invention comprising the step of affixing a label to at least one chain link plate by means of an adhesive. Such a method for marking a drive chain allows an easy and fully automatic identification of drive chains in the chain strand during the production of the drive chain without stopping the production process. By means of marking through labels, it is also possible to identify process faults directly on the respective chain links of the chain strand during the process. The identification process of a drive chain for an internal combustion engine, e.g. in the case of timing chains, may take place directly before the chain is closed. Subsequent faults resulting from the production of the chain strand can thus be prevented and the reject rate can be reduced accordingly. This special embodiment, according to which a self-adhesive label is affixed to the at least one chain link plate directly during the production of the drive chain and before the drive chain is closed, with the self-adhesive label being configured as a polyester film, preferably a polyester film laminate, and provided with an adhesive on a basis of a cross-linkable acrylate polymer, simplifies the production process of closed drive chains and allows simultaneously a reliable marking and product identification of the drive chain.

### BRIEF DESCRIPTION OF THE DRAWINGS

In the following, one embodiment of the present invention will be explained in more detail making reference to a drawing, in which:

FIG. 1 shows a schematic view of a chain drive in an internal combustion engine with a drive chain according to the present invention,

FIG. 2 shows a perspective side view of part of a drive chain according to the present invention, and

FIG. 3 shows a side view of the drive chain according to FIG. 2.

### DETAILED DESCRIPTION

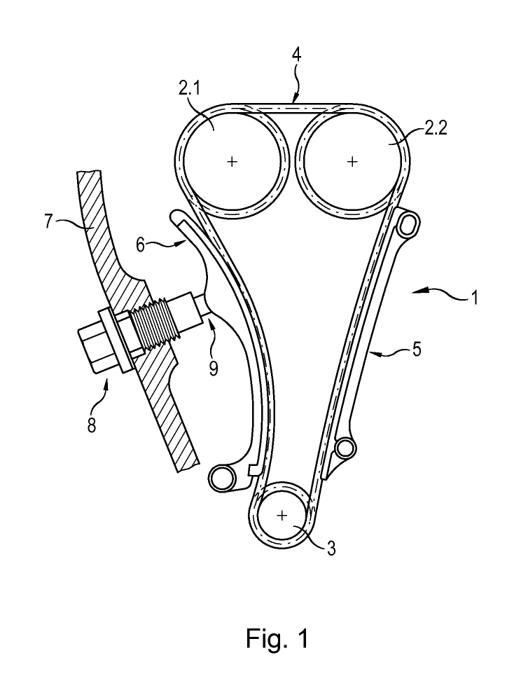

FIG. 1 shows a timing chain drive for an internal combustion engine. This timing chain drive 1 comprises two overhead camshaft chain wheels 2.1 and 2.2, a lower crankshaft chain wheel 3, a drive chain 4, i.e. a timing chain, wrapped around these chain wheels, a slide rail 5 and a pivotably arranged tensioning rail 6 pressed against the drive chain 4 by means of a chain tensioner 8 screwed in position in the crankcase 7. The chain tensioner 8 is normally connected to the engine oil hydraulic system so that its tensioning piston 9 is hydraulically pressed onto the pivotably arranged tensioning rail 6 thus keeping the drive chain 4 under tension. Both the slide rail 5 and the tensioning rail 6 abut with their sliding covers on the outer surface of the drive chain 4 running therealong.

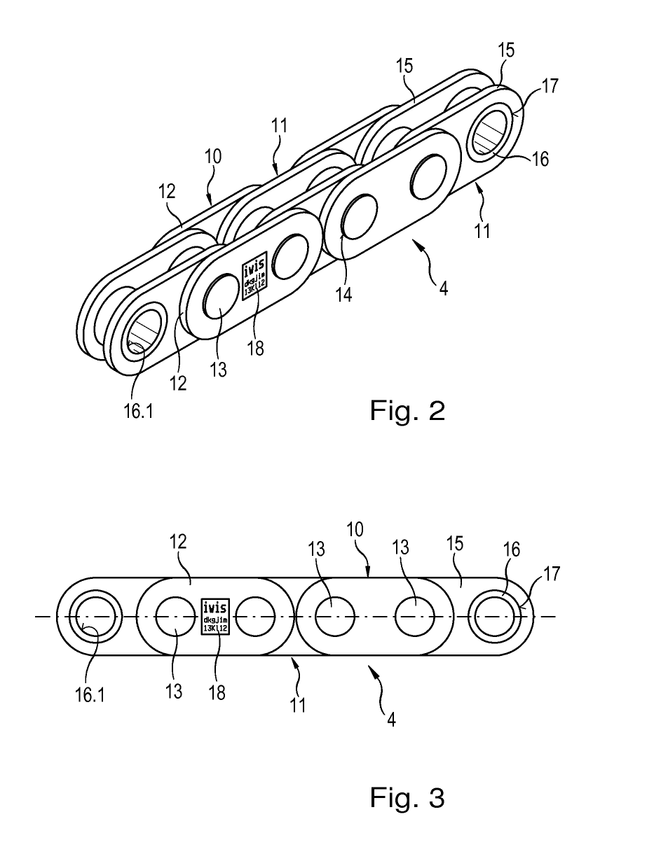

On the basis of FIGS. 2 and 3, a first embodiment of a drive chain 4 according to the present invention is shown in detail. The drive chain 4 comprises alternate outer chain links 10 and inner chain links 11 which are interconnected by means of a chain hinge. Each outer chain link 10 consists of two spaced-apart outer link plates 12 and two cylindrically shaped joint pins 13 interconnecting these outer link plates 12. To this end, the joint pins 13 are press-fitted into associated pin openings 14 in said outer link plates 12 such that they slightly project beyond said outer link plates 12. Each inner chain link 11 consists of two spaced-apart inner link plates 15 interconnected by means of two longitudinally spaced joint bushings 16. To this end, the joint bushings 16 are press-fitted into adequately shaped bushing openings 17 of the inner link plate 15. A joint pin 13 of the outer chain link 10 and an associated joint bushing 16 of an inner chain link 11, through which this joint pin 13 extends, define together a chain hinge. The inner side of the joint bushing 16 thus forms the joint surface 16.1.

In the embodiments of the drive chain 4 according to the present invention shown in FIGS. 2 and 3, a colored label is affixed to the outer surface of the outer link plates 12 by means of an adhesive, said colored label being used for identifying the drive chain 4, e.g. for adjusting the timing control in a timing chain drive, as well as for recording essential product data concerning the drive chain 4. The mark 18 is preferably positioned centrally on the outer surface of the outer link plate 12 of the outer chain links 10 between the joint pins 13 and is substantially rectangular in shape. Depending on the respective case of use, also other shapes of marking labels 18 may be used.

When a drive chain 4 according to the present invention is being produced and assembled, the inner chain link 11 is first formed by pressing the inner link plates 15 onto the joint bushings 16. Subsequently, the inner chain link 11 is joined to the already assembled portion of the drive chain 4 by means of an outer chain link 10. To this end, an outer chain pin block is first formed by riveting the two joint pins 13 to an outer chain link plate 12. The free ends of the joint pins 13 of this outer chain pin block are passed through the joint bushings 16 of the already assembled portion of the drive chain 4 as well as of the adjoining inner chain link 11. Then, the ends of the joint pins 13 projecting on the opposite side of the inner chain links 11 are inserted into the pin openings 14 of the second outer link plate 12 and riveted to the outer link plate 12. The application of the marking labels 18 at a specific position is then carried out either in the open, already assembled chain strand or after the chain has been cut to length during closing of the drive chain 4.

1. A drive chain for an internal combustion engine, comprising:
a plurality of chain links, each chain links having at least one chain link plate and a chain hinge interconnecting via the chain links,
at least one chain link plate having a mark, which is configured as a label affixed to the at least one chain link plate by means of an adhesive layer, and
wherein the label is configured as a laminate film, the laminate film having a first polyester film with marking information and a second, transparent polyester film, which covers and protects the first polyester film with the marking information when the drive chain is in operation.

2. The drive chain of claim 1, wherein the first and second polyester films of the label exhibit a temperature resistance of at least 130° C.

3. The drive chain of claim 2, wherein the first and second polyester films of the label exhibit a temperature resistance of at least 150° C.

4. The drive chain of claim 1, wherein the thickness of the first and second polyester films is less than 0.05 mm.

5. The drive chain of claim 4, wherein the thickness of the first and second polyester films is less than 0.03 mm.

6. The drive chain of claim 1, wherein the label is configured as a self-adhesive label and the adhesive layer adheres to the label.

7. The drive chain of claim 1, wherein an adhesive of the adhesive layer comprises a cross-linked acrylate polymer.

8. The drive chain of claim 7, wherein the cross-linkable acrylate polymer of the adhesive comprises butyl acrylate and/or acrylic acid.

9. The drive chain of claim 7, wherein the adhesive comprises a pressure-activatable cross-linking agent.

10. The drive chain of claim 7, wherein the adhesive comprises a heat-activatable cross-linking agent.

11. The drive chain of claim 7, wherein the adhesive of the adhesive layer has an adhesive power of at least 20 N/25 mm, preferably at least 25 N/25 mm.

12. The drive chain of claim 1, wherein the drive chain is a timing drive chain for an internal combustion engine.

13. A method for marking a drive chain for an internal combustion engine comprising a plurality of chain links, each chain link having at least one chain link plate and a chain hinge interconnecting the chain links, wherein at least one chain link plate has a marking label, which is configured as a laminate film having first and second polyester films, wherein the first polyester film with marking information is affixed to the chain link plate by means of an adhesive and is covered with the second, transparent polyester film, which protects the first polyester film with the marking information when the drive chain is in operation.

14. The method for marking a drive chain of claim 13, wherein the marking label is a self-adhesive label and is affixed to the at least one chain link plate before the drive chain is closed during the production of the drive chain.
